(19) United States
(12) Patent Application Publication
(10) Pub. No.: US 2008/0094376 A1
(43) Pub. Date: Apr. 24, 2008

(54) Stylus calibration system and method

(76) Inventor: Paul H. Dietz, Hopkinton, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/584,969

(22) Filed: Oct. 23, 2006

(51) Int. Cl. G06F 3/033

(52) U.S. Cl. 345/179

(57) ABSTRACT

A method calibrates a stylus to a display interface by first resetting a calibration pattern and calibration parameters. The calibration pattern is displayed on the display interface at a location corresponding to an estimated position of a stylus tip. The position of the stylus tip is measured while sensing the calibration pattern with a photosensor arranged on the stylus tip. If coordinates of the location are equal to coordinates of the position, then the resetting, displaying, measuring and determining steps are repeated periodically, and otherwise a size of the calibration pattern is increased and the displaying, measuring and determining steps are repeated.

### FIELD OF THE INVENTION

This invention relates generally to stylus-based input interfaces, and more particularly to calibrating styluses to display interfaces.

### BACKGROUND OF THE INVENTION

Many interfaces for computerized devices use a handheld stylus for input. The stylus is typically used in conjunction with an output display interface. Generally, a calibration process maps coordinates provided by the sensors to the display coordinates. Typically, the calibration process displays calibration points that need to be touched during an initialization phase.

There are several problems with such calibration. The calibration is only valid when the user touches the displayed calibration points exactly. The calibration is subject to drift, and needs to be repeated periodically. The calibration is a separate manual step that requires time and effort of the user.

Therefore, there is a need for automatic stylus calibration.

### BRIEF DESCRIPTION OF THE DRAWINGS

FIG. 1 is a block diagram of a system for calibrating a stylus to a display interface according to an embodiment of the invention; and

FIG. 2 is a flow diagram of a method for calibrating a stylus to a display interface according to an embodiment of the invention.

### DETAILED DESCRIPTION OF THE PREFERRED EMBODIMENTS

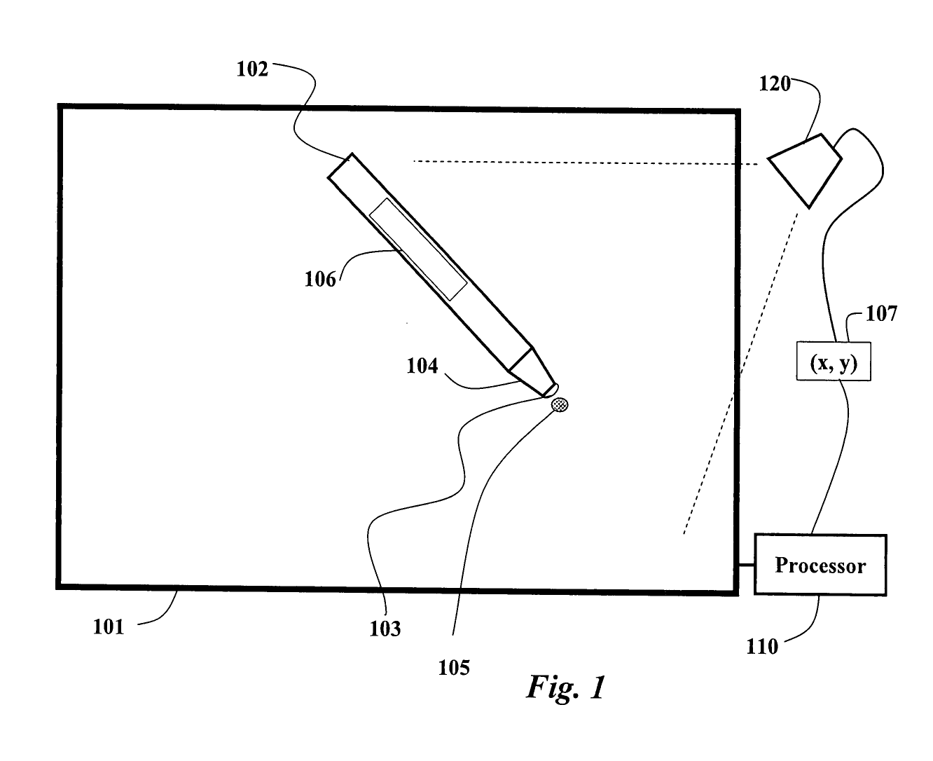

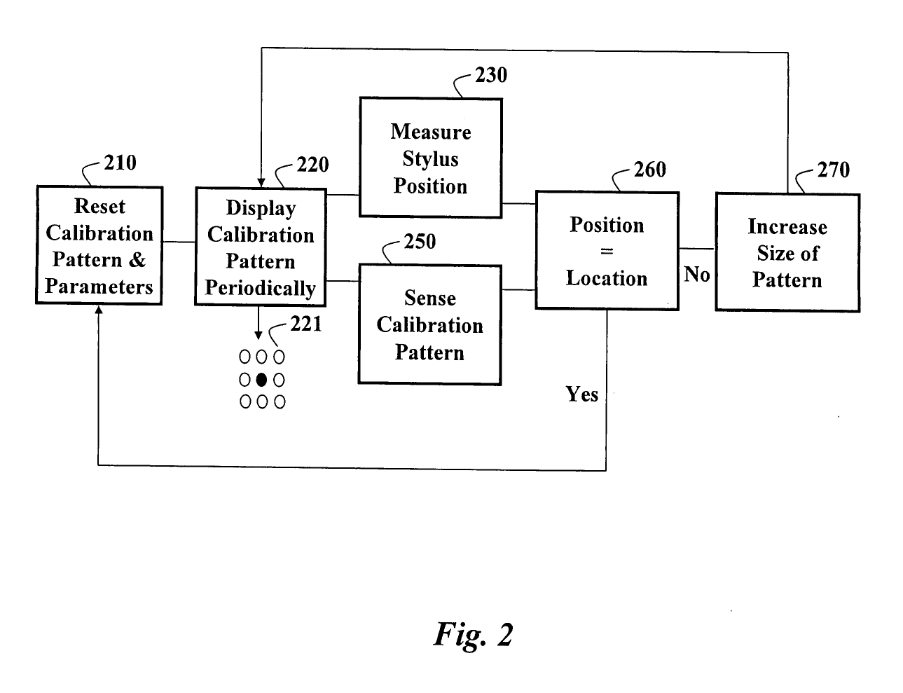

FIG. 1 shows of a system for continuously calibrating a stylus to a display interface according to an embodiment of the invention. FIG. 2 shows a calibration method according to an embodiment of the invention. A display interface 101 is used in conjunction with a handheld stylus 102. The stylus is used to point at locations on the display interface. The stylus includes a photosensor 103 arranged at the tip 104 of the stylus. The photosensor can sense 250 a state of the display interface at display coordinates (X,Y) 105 at a display location in an immediate vicinity of the tip 104. The sensed state can be an intensity of the pixel located at coordinates (X, Y). The stylus can include a transmitter 106 to transmit the sensed state to a processor 110. Alternatively, the stylus can be connected directly to the processor. Coordinates (x, y) 107 of positions of the stylus are measured 230 by a tracking subsystem 120, e.g., a camera or an ultrasonic sensor.

During operation, the calibration pattern and calibration parameters are initially reset 210 to be a single pixel located on the display at an estimated position of the stylus. The processor generates and displays 220 the calibration pattern for the pixel at the location (X, Y) by modulating the intensity of the pixel in a predetermined manner. For example, the pixel can periodically be turned on and off. Alternatively, the pattern can be a spatio-temporal mixture intensities and or color. Because the calibration pattern is very small, e.g., one pixel, and displayed 220 at the tip 104 of the sensor 102, the pattern will usually not be visible to the user.

The position (x, y) 107 of the stylus 102 is measured 230 while a state of the 101 is sensed 250. If the calibration pattern is detected (Yes), then the stylus is calibrated, i.e., display location (X, Y)=stylus position (x, y). In this case, the calibration pattern and the calibration parameters can be reset 210, and the process is repeated periodically.

The tracking subsystem can drift slowly over time. This is typically the case. That is, the pixel location 105 and the stylus position 107 will only vary slightly, for example, by a single pixel. Thus, if the calibration pattern is not detected (No), then a size of the pattern is increased 270, and additional pixels near the location (X, Y) are modulated and displayed 220 as part of the calibration pattern 221. For example, the size of the pattern can be increased by one pixel for each iteration.

The calibration pattern can be part of, or appears as a displayed cursor. The number of pixels that are modulated can gradually be increased 270 until the calibration pattern is detected in step 260, and the calibration parameters are reset accordingly, and the calibration pattern is also reset 210 to a single pixel.

A number of transformation models are known for converting among local coordinate systems. Typically, the models consider translation, scaling and rotation between the coordinate systems. It is an object of the above described calibration method to determine the optimal parameters for this model. In general Kalman filtering or related recursive estimation can be used to fit the transformation model to the sensed coordinates.

As an advantage, the calibration is continuous and unobtrusive, and provides for calibration parameter correction in the presence of slow drift.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

I claim:

1. A method for calibrating a stylus to a display interface, comprising the steps of:
resetting a calibration pattern and calibration parameters;
displaying the calibration pattern at a location of the display interface corresponding to an estimated position of a stylus tip;
measuring the position of the stylus tip while sensing the calibration pattern with a photosensor arranged on the stylus tip;
determining if coordinates of the location are equal to coordinates of the position;
repeating periodically, if the coordinates of the location are equal to the coordinates of the position, the resetting, displaying, measuring and determining steps, and otherwise;
increasing a size of the calibration pattern and repeating the displaying, measuring and determining steps.

2. The method of claim 1, in which the reset calibration pattern is a single pixel.

3. The method of claim 1, further comprising:
modulating an intensity of the calibration pattern while sensing.

4. The method of claim 1, in which the position of the stylus is sensed with a camera.

5. The method of claim 1, in which the position of the stylus tip is sensed with an ultrasonic sensor.

6. The method of claim 1, in which the size of the calibration pattern is increased by one pixel.

7. A system for calibrating a stylus to a display interface, comprising:
means for resetting a calibration pattern and calibration parameters;
means for displaying the calibration pattern at a location of the display interface corresponding to an estimated position of a stylus tip;
means for measuring the position of the stylus tip while sensing the calibration pattern with a photosensor arranged on the stylus tip;
means for determining if coordinates of the location are equal to coordinates of the position;
means for repeating periodically, if the coordinates of the location are equal to the coordinates of the position, the resetting, displaying, measuring and determining steps, and otherwise;
means for increasing a size of the calibration pattern and repeating the displaying, measuring and determining steps.
